(19) United States
(12) Patent Application Publication
(10) Pub. No.: US 2017/0035157 A1
(43) Pub. Date: Feb. 9, 2017

(54) DEVICE AND A METHOD TO PROVIDE MOTIVATION TO ACHIEVE GOALS

(71) Applicant: Rolf C. Heitmann, Portsmouth, RI (US)

(72) Inventor: Rolf C. Heitmann, Portsmouth, RI (US)

(21) Appl. No.: 14/820,331

(22) Filed: Aug. 6, 2015

(51) Int. Cl. A44C 5/00; G09B 19/00

(52) U.S. Cl. CPC A44C 5/0015; G09B 19/00

(57) ABSTRACT

A device for motivating a user to achieve a goal and a method of using the device has been provided. The device comprises a bracelet and a set of detachable elements. The goal to be achieved is broken down into a set of sub-goals. Each sub-goal is associated with one of the detachable elements. All the detachable elements corresponding to all the sub-goals of the goal are attached to the bracelet. The user wears the bracelet while trying to achieve the goal by achieving the sub-goals one by one. For each achieved sub-goal the user removes a detachable element associated with the achieved sub-goal as an indication of the achievement of the user. This provides the user the motivation to complete the set of sub-goals to achieve the goal.

### FIELD OF THE INVENTION

The present invention relates generally to methods and devices for motivating users to achieve their goals. The present invention is more particularly directed to a method and a device utilizing a bracelet and a plurality of detachable elements to deliver motivation to users to help achieve their goals.

### BACKGROUND OF THE INVENTION

Motivation, whether from self or from an outside source, is a key factor in achieving any goals a user might have set. No matter how self-motivated a person is, over a period of time it becomes increasingly difficult to sustain the same level of motivation to work on a task to achieve a set goal as was at the beginning of the task.

One of the most commonly found examples depicting loss of motivation in long run is weight loss goals. Often a user sets a certain weight loss goal and starts with high levels of enthusiasm which slowly depletes during the course of a regime (exercise, diet, etc.) that one need to follow to achieve the desired weight loss goal. An outside source of motivation could be of help in such a situation. Such an outside source could either be a device or a person providing some form of motivation, positive reinforcement and encouragement to keep the user on track of achieving the set goals.

In past, several methods and devices have been proposed in the prior art to provide a solution to the problem of providing sustained motivation to help achieve one's goals. However, none of the existing methods and devices has provided a satisfactory solution and has numerous limitation and drawbacks. Clearly, there is a need for a solution which should be easy to implement but should also be able to serve as a source of motivation, positive reinforcement, encouragement and constant reminder to keep users on track of achieving their set goals.

### SUMMARY OF THE INVENTION

It is an object of the present invention to provide a device and associated method of use which can provide motivation to users to achieve their goals.

It is another object of the present invention to provide a device and associated method of use which can serve as a constant reminder to users to achieve their goals.

It is yet another object of the present invention to provide a device and associated method of use which can provide a status update on the efforts of the users to achieve their goals.

To achieve these three objects and more, the present invention provides a device comprising a bracelet and a plurality of detachable elements. The present invention also provides a method of use of the device. Depending upon a goal set by a user, the user can break down the goal in a plurality of sub-goals. Each of these sub-goals would correspond to one of the plurality of detachable elements. At the start of a task to achieve the goal a user will wear the bracelet with all the detachable elements attached to the bracelet, as per a preferred embodiment of the present invention. As the user keeps achieving the sub-goals, the user can detach the corresponding detachable elements. Detaching the corresponding detachable elements will provide a sense of achievement to the user. At the same time the remaining detachable elements will serve as a reminder to the user that the goal is yet to be achieved and will also provide a status update on how many more sub-goals are remaining to achieve to complete the goal.

All the advantages and features of the present invention will be set forth in the description which follows, and will become apparent to those skilled in the art upon examination of the following, or may be learned by practice of the invention. These advantages and features of the present invention will be more readily apparent when considered in reference to the following description and when taken in conjunction with the drawings below.

### DESCRIPTION OF THE DRAWINGS

FIG. 1 shows a bracelet component of a device in an open configuration as per an exemplary non-limiting first embodiment of the present invention;

FIG. 2 shows the bracelet component of the device in a closed configuration as per the exemplary non-limiting first embodiment of the present invention;

FIG. 3 shows a set of detachable elements as per the exemplary non-limiting first embodiment of the present invention;

FIG. 4a shows the set of detachable elements attached to the bracelet component of the device in a first configuration, as per the exemplary non-limiting first embodiment of the present invention;

FIG. 4b shows the set of detachable elements attached to the bracelet component of the device in a second configuration, as per the exemplary non-limiting first embodiment of the present invention;

FIG. 5a shows a set of detachable elements attached to the bracelet component of the device in a first configuration as per an exemplary non-limiting second embodiment of the present invention;

FIG. 5b shows the set of detachable elements attached to the bracelet component of the device in a second configuration, as per the exemplary non-limiting second embodiment of the present invention; and

FIGS. 6a-6e shows a set of detachable elements as per an exemplary non-limiting third embodiment of the present invention.

### DETAILED DESCRIPTION OF THE INVENTION

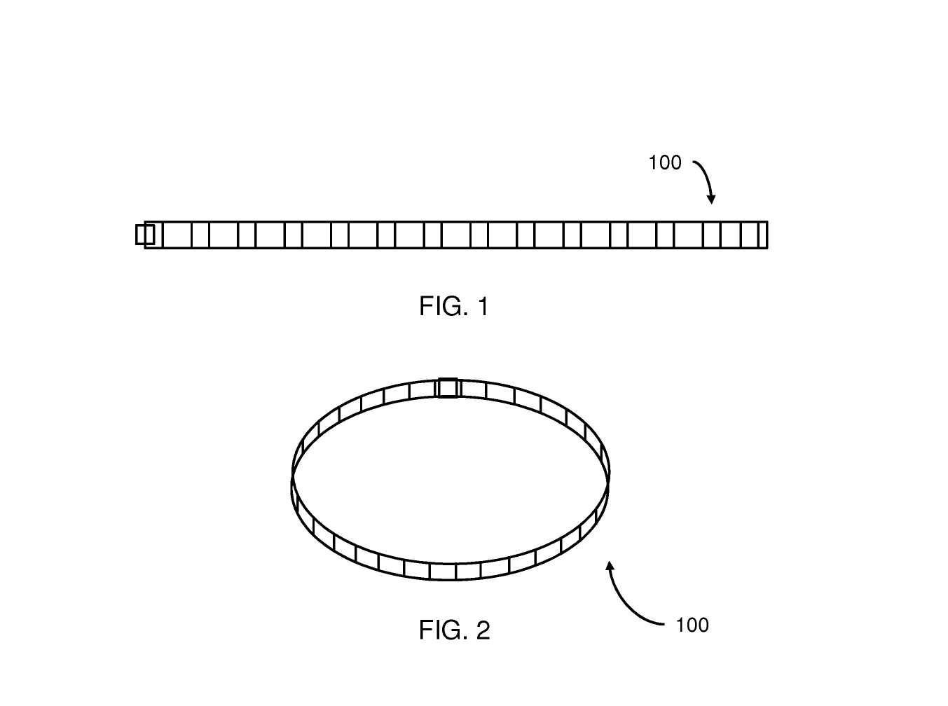

A device and an associated method of use as per the present invention have been explained henceforth using an exemplary non-limiting first embodiment with reference to FIGS. 1 to 4b.

As per this exemplary non-limiting first embodiment, the present invention provides a device comprising a bracelet and a plurality of detachable elements and a method of use of the device to achieve desired objectives.

The bracelet 100, as shown in FIG. 1 in an open configuration, as per this preferred exemplary non-limiting first embodiment, is made of a metal or a metallic alloy to ensure strength to stand daily wear & tear due to regular use. It would be apparent to those skilled in the art that a variety of metals and metallic alloys known in the existing arts can be used for this purpose. It would also be apparent to those skilled in the art that the bracelet 100 can be made of non-metallic materials known in the arts, such as plastic, rubber and leather.

FIG. 2 shows the bracelet 100 in a closed configuration as per the exemplary non-limiting first embodiment of the present invention. This configuration is useful for a user to wear the bracelet 100 on the wrist for daily use, ensuring that the bracelet 100 doesn't fall off. It would be apparent to those skilled in the art that the closed configuration of the bracelet 100 can be achieved by securing together the two distal ends of the bracelet 100 using a variety of methods known in the existing arts. Examples of such methods can be using a buckle, clasp, latch or magnetic closure to achieve the closed configuration.

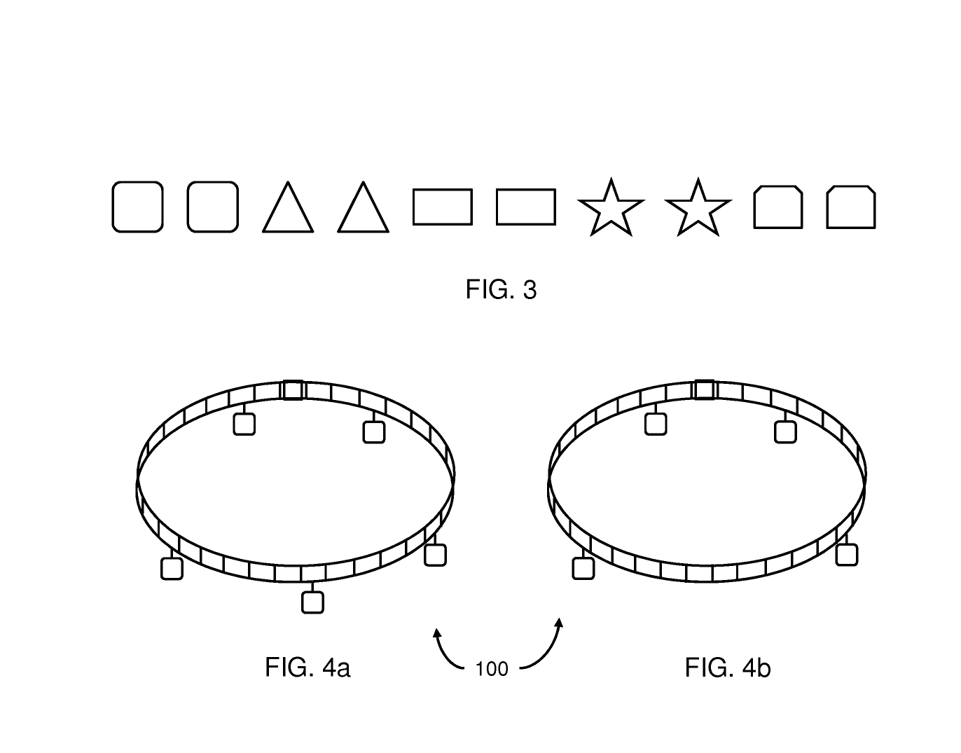

The detachable elements of various shapes and sizes, as shown in FIG. 3, as per this preferred exemplary non-limiting first embodiment, are made of a metal or a metallic alloy to ensure strength to stand daily wear & tear due to regular use. It would be apparent to those skilled in the art that a variety of metals and metallic alloys known in the existing arts can be used for this purpose. It would also be apparent to those skilled in the art that the detachable elements can be made of non-metallic materials known in the arts, such as plastic, rubber and leather.

FIGS. 4a and 4b would now be used to explain a method of use of the device by a user as per the exemplary non-limiting first embodiment of the present invention. Once the user sets a goal, say for example to lose weight, this goal can be broken down into set of sub-goals, such as losing small increments of weight over time which will add up to achieve the desired total weight loss goal. Now, each of the sub-goals can be associated with a detachable element.

To explain better by way of a non-limiting example, if the user wants to lose 20 lbs. then this goal can be broken down into 5 sub-goals of 4 lbs. each, and there could be 5 detachable elements corresponding to the 5 sub-goals. It will be apparent to those skilled in the art that the user can choose to break down the goal in to sub-goals of equal weightage as well. For example, in a different embodiment the user can choose to have 2 sub-goals of 4 lbs. each and 2 sub-goals of 6 lbs. each.

At the start of a task to achieve the goal the user would wear the bracelet 100 on one of the wrists with all the 5 detachable elements attached to the bracelet 100, forming a first configuration as shown in FIG. 4a. If the detachable elements are of unequal weightage, as explained above, the user may choose to put the detachable elements in a particular order on the bracelet 100. Now, as the user will work on the task to achieve the goal of losing the 20 lbs., the user will be constantly reminded of the goal the user has set. Even if sometimes the user feels lazy to work out or is tempted to cheat on a diet, presence of the device on the wrist of the user will motivate the user to keep working towards achieving the goal, one sub-goal at a time.

Once the user loses the first 4 lbs. the user will remove one of the 5 detachable elements from the bracelet 100, as per the non-limiting example, forming a second configuration as shown in FIG. 4b. This act will provide the user a sense of achievement and will motivate to pursue the rest of the sub-goals to finally achieve the desired goal. At the same time, the remaining 4 detachable elements on the bracelet 100 would serve as a reminder to the user that this was only the first sub-goal and the user still needs to achieve four more sub-goals. Thus, the device will provide a sense of achievement to the user and at the same time will serve as a reminder to the user that the goal is yet to be completed with a status update on how many more sub-goals are remaining.

Once the goal is achieved, i.e. all the 5 detachable elements have been removed from the bracelet 100, the user will feel emotionally light looking at only the remaining bracelet which will remind the user of completion of the goal and providing a sense of achievement as well as motivation to set and achieve any future goals.

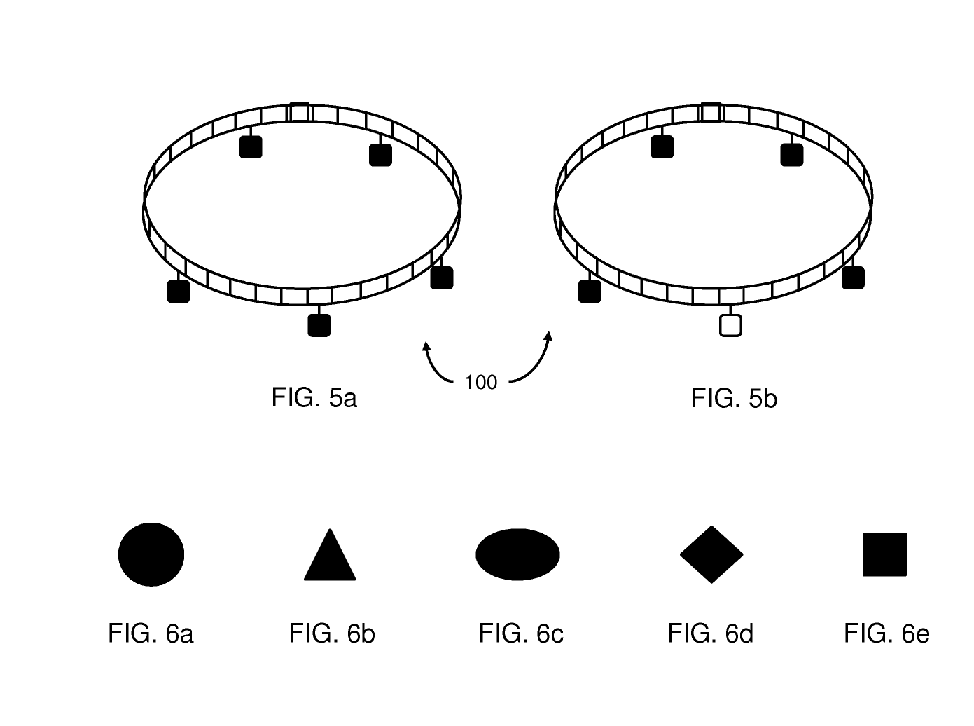

FIGS. 5a and 5b would now be used to explain a method of use of the device by a user as per the exemplary non-limiting second embodiment of the present invention. We will use the example of weight loss goal of 20 lbs., broken down into 5 sub-goals of 4 lbs. with corresponding 5 detachable elements, as explained above, to explain the method of use as per this second embodiment of the present invention.

At the start of a task to achieve the goal the user would wear the bracelet 100 on one of the wrists with all the 5 detachable elements attached to the bracelet 100, forming a first configuration as shown in FIG. 5a. As shown in FIG. 5a, all the 5 detachable elements will have an opaque removable cover, hiding the faces of the detachable elements. Now, as the user will work on the task to achieve the goal of losing the 20 lbs., the user will be constantly reminded of the goal the user has set. Even if sometimes the user feels lazy to work out or is tempted to cheat on a diet, presence of the device on the wrist of the user will motivate the user to keep working towards achieving the goal, one sub-goal at a time.

Once the user loses the first 4 lbs. the user will remove the opaque cover covering the faces of one of the 5 detachable elements from the bracelet 100, forming a second configuration as shown in FIG. 5b. This act will provide the user a sense of achievement and will motivate to pursue the rest of the sub-goals to finally achieve the desired goal. At the same time, the opaque removable covers covering the faces of the remaining 4 detachable elements on the bracelet 100 would serve as a reminder to the user that this was only the first sub-goal and the user still needs to achieve four more sub-goals. Thus, the device will provide a sense of achievement to the user and at the same time will serve as a reminder to the user that the goal is yet to be completed with a status update on how many more sub-goals are remaining.

Once the goal is achieved, i.e. the opaque covers covering the faces of all the 5 detachable elements have been removed from the bracelet 100, the user will feel emotionally better looking at the bracelet and the uncovered detachable elements which will remind the user of completion of the goal, providing a sense of achievement as well as motivation to set and achieve any future goals. In this second embodiment of the present invention the elements are detachable so that the elements can be added or removed from the bracelet 100 depending upon any future goals and the corresponding number of sub-goals that the user sets to achieve.

As per the two methods explained above in the first and the second exemplary non-limiting embodiments of the present invention, it will be readily apparent to those skilled in the art that shape and size of the bracelet 100 and the detachable elements do not affect the execution of the methods. The bracelet 100 and the detachable elements can have a plurality of designs as per various embodiments of the present invention as long as the designs permit attaching and removing the detachable elements from the bracelet 100.

FIGS. 6a-6e, depicting detachable elements with a removable opaque cover, would now be used to explain a method of use of the device by a user as per the exemplary non-limiting third embodiment of the present invention. We will use an example of weight loss goal of 20 lbs., broken down into 4 sub-goals of 5 lbs. with corresponding 4 detachable elements, to explain the method of use as per this third embodiment of the present invention. As per this third embodiment, shapes of the detachable elements can be associated to various stages of achieving the goal set by the user. Thus, shapes of the detachable elements can be pre-defined corresponding to the nature of a sub-goal. Similarly, different colors of the detachable elements can be associated to different goal categories in a pre-defined manner. For example, weight loss goal category can be associated to maroon color and travel goal category can be associated to green color. So, in this weight loss example to explain the third embodiment, all the detachable elements will be of maroon color.

Now, a circular shaped detachable element, as shown in FIG. 6a, can be associated to signifying start of the journey to achieve the goal of losing 20 lbs. An oval shaped detachable element can be associated to a sub-goal of reaching halfway of the goal, i.e. losing 10 lbs. in this example. A triangle shaped detachable element can be associated to representing each sub-goal, except for the halfway goal. A diamond shaped detachable element can be associated to achieving the desired goal of 20 lbs.

Now, when the user sets on the task to lose 20 lbs., the user will wear the bracelet 100 with the following detachable elements attached to the bracelet 100 in the order mentioned: a circular shaped detachable element as shown in FIG. 6a (starting the journey to achieve a goal of weight loss of 20 lbs.), a first triangle shaped detachable element as shown in FIG. 6b (first sub-goal of achieving 5 lbs. of weight loss), an oval shaped detachable element as shown in FIG. 6c (halfway sub-goal of achieving total 10 lbs. of weight loss), a second triangle shaped as shown in FIG. 6b (third sub-goal of achieving 5 lbs. of weight loss), a diamond shaped detachable element as shown in FIG. 6d (signifying goal achievement of 20 lbs. weight loss). All the detachable elements will have opaque removable covers covering the faces of the detachable elements.

As the user starts the task to achieve the desired goal of weight loss of 20 lbs., the user will remove the opaque cover covering the face of the circular shaped detachable element. This will signify that the user has started working towards achieving the goal. Once the user loses the first 4 lbs. the user will remove the opaque cover covering the faces of the first triangle shaped detachable element. This act will provide the user a sense of achievement and will motivate to pursue the rest of the sub-goals to finally achieve the desired goal. At the same time, the opaque removable covers covering the faces of the remaining 4 detachable elements on the bracelet 100 would serve as a reminder to the user that this was only the first sub-goal and the user still needs to achieve four more sub-goals. Thus, the device will provide a sense of achievement to the user and at the same time will serve as a reminder to the user that the goal is yet to be completed with a status update on how many more sub-goals are remaining.

Next, as the user achieves total 10 lbs. weight loss, the user will remove the opaque cover covering the faces of the oval shaped detachable element. This will signify that the user has reached halfway towards achieving the goal. Similarly, on achieving total 15 lbs. weight loss the user will remove the opaque cover covering the faces of the second triangle shaped detachable element. Finally, upon completion of the goal, i.e. losing 20 lbs. of weight the user will remove the opaque cover covering the faces of the diamond shaped detachable element.

Once the goal is achieved, i.e. the opaque covers covering the faces of all the 5 detachable elements have been removed from the bracelet 100, the user will feel emotionally better looking at the bracelet and the uncovered detachable elements which will remind the user of completion of the goal, providing a sense of achievement as well as motivation to set and achieve any future goals.

The user can choose to continue wearing the bracelet 100 with all the detachable elements or the user can choose to wear the bracelet 100 with only the maroon colored, diamond shaped detachable element to display achievement of the weight loss goal set by the user. Now when the user sets the next goal, say from the travel category of travelling a certain number of countries, the user may keep the maroon-colored diamond shaped detachable element on the bracelet 100 and may start with a set of green colored detachable elements while following the method as explained above. Thus the user may keep accumulating various diamond shaped elements signifying various goals completions and providing an increasing sense of achievement which will in turn keep motivating the user to set and achieve more goals. The user may also chose to remove the diamond shaped detachable element before starting a new goal and attaching associated detachable elements on the bracelet 100.

Once the user completes a certain time frame after accomplishing a goal and if the user has been able to maintain the achieve goal, for example a one year anniversary of completing 20 lbs. weight loss and maintaining the new weight, the user may choose to signify the occasion by attaching a square shaped detachable element, as shown in FIG. 6e, to the bracelet 100 which will be of maroon color associated to the weight loss category. This will further motivate the user to keep working to maintain the weight to achieve a second maroon colored square shaped detachable element the next year and so on. Similar logic applies to goals from all other categories set by the user. When attaching a square shaped detachable element the user may or may not choose to remove the diamond shaped detachable element of the associated goal category from the bracelet 100.

It will be apparent to those skilled in the art that the objects of the present invention have been achieved by providing the above system and method. Various modifications to the above described invention will be readily apparent to those skilled in the art and the general principles defined herein may be applied to other embodiments and applications without departing from the spirit and scope of the present invention. Thus, the present invention is not intended to be limited to the embodiments described, but is to be accorded the widest scope consistent with the principles and features disclosed herein. Therefore, the scope of the invention is to be determined by the terminology of the above description and the legal equivalents thereof.

What is claimed is:

1. A method for motivating a user to achieve a goal comprising:
breaking down the goal into a set of sub-goals;
associating each sub-goal from the set of sub-goals with a detachable element, wherein all the detachable elements corresponding to the set of sub-goals are attached to a bracelet, and wherein the user wears the bracelet with all the detachable elements attached to the bracelet;
allowing the user to achieve a sub-goal from the set of sub-goals; and
removing a detachable element associated with the achieved sub-goal as an indication of the achievement of the user to provide the user the motivation to complete the set of sub-goals to achieve the goal.

2. The method of claim 1, additionally comprising:
pre-defining association of a color with a goal category; and
using all the detachable elements of the pre-defined goal-category associated color.

3. The method of claim 1, wherein the detachable elements are of different pre-defined shapes, and wherein each of the different pre-defined shapes of the detachable elements is associated to a sub-goal from the set of sub-goals depending upon the nature of the sub-goal.

4. A method for motivating a user to achieve a goal comprising:
breaking down the goal into a set of sub-goals;
associating each sub-goal from the set of sub-goals with a detachable element covered in a removable opaque cover, wherein all the detachable elements corresponding to the set of sub-goals are attached to a bracelet, and wherein the user wears the bracelet with all the detachable elements attached to the bracelet;
allowing the user to achieve a sub-goal from the set of sub-goals; and
removing an opaque cover of a detachable element associated with the achieved sub-goal as an indication of the achievement of the user to provide the user the motivation to complete the set of sub-goals to achieve the goal.

5. The method of claim 4, additionally comprising:
pre-defining association of a color with a goal category; and
using all the detachable elements of the pre-defined goal-category associated color.

6. The method of claim 4, wherein the detachable elements are of different pre-defined shapes, and wherein each of the different pre-defined shapes of the detachable elements is associated to a sub-goal from the set of sub-goals depending upon the nature of the sub-goal.

7. A device for motivating a user to achieve a goal comprising:
a bracelet; and
a set of detachable elements, wherein each detachable element from the set of detachable elements is associated to a sub-goal from a set of sub-goals corresponding to the goal to be achieved, and wherein the user removes a detachable element associated with a sub-goal achieved by the user while trying to achieve the goal as an indication of the achievement of the user to provide the user the motivation to complete the set of sub-goals to achieve the goal.

8. The device of claim 7, wherein the set of detachable elements comprises detachable elements of different pre-defined shapes, and wherein each of the different pre-defined shapes of the detachable elements is associated to a sub-goal from the set of sub-goals depending upon the nature of the sub-goal.

9. The device of claim 7, wherein the set of detachable elements comprises detachable elements of different colors, and wherein each of the different colors of the detachable elements is associated to a category of goal in a pre-defined manner.
